(19) United States
(12) Patent Application Publication
(10) Pub. No.: US 2026/0260456 A1
(43) Pub. Date: Sep. 3, 2026

(54) INTERFACE DIFFERENCE DETECTION SYSTEM

(71) Applicant: Intuit Inc., Mountain View, CA (US)

(72) Inventors: Kevin Michael FURBISH, Tampa, FL (US); Zhiyue DING, Sunnvale, CA (US)

(21) Appl. No.: 19/067,532

(22) Filed: Feb. 28, 2025

(51) Int. Cl. G06V 10/75; G06T 7/00; G06T 7/11; G06V 30/10

(52) U.S. Cl. CPC G06V 10/751; G06T 7/001; G06T 7/11; G06V 30/10

(57) ABSTRACT

Certain aspects of the disclosure provide techniques for image processing, including identifying a first set of segments within a first image and a second set of segments within a second image; identifying one or more pairs of matching segments; determining one or more differences between the first image and the second image by comparing matched segments within the one or more pairs of matching segments; and generating an indication of differences comprising: a similarity score indicating a similarity between the first image and the second image, an image-based output comprising one or more visual indications of the one or more differences in one or both of the first image and the second image, and a text-based output comprising one or more text descriptions of the one or more differences between the first image and the second image.

### BACKGROUND

### Field

Aspects of the present disclosure relate to image analysis and comparison.

### Description of Related Art

Software applications regularly undergo updates to maintain security, improve performance, add new features, and fix bugs that emerge as technology evolves and user needs change. These updates can range from minor patches that fix a bug in the source code to major version releases that significantly alter the application's functionality or architecture. Developers continuously monitor software applications for vulnerabilities, gather user feedback, and analyze performance metrics to determine what changes are necessary. Additionally, updates may be required to ensure compatibility with new operating systems, hardware, or third-party dependencies that the software relies upon.

The process of updating software varies depending on the application type and deployment method. For traditional desktop applications, updates typically involve downloading and installing new files that replace or modify existing program components. Modern applications often implement automatic update systems that handle this process in the background, minimizing user interruption. Web-based applications can be updated on the server side without requiring direct user action, though users may need to refresh their browsers or clear their cache to access the new version. Mobile apps generally update through their respective app stores, which manage the download and installation process.

Software updates may affect the look and feel of a software interface, and thereby the user experience. Consequently, users may be hesitant to update their software applications when prompted to do so.

### SUMMARY

Certain aspects provide a method including identifying a first set of segments within a first image and a second set of segments within a second image; identifying one or more pairs of matching segments, wherein a pair of matching segments comprises a first segment of the first set of segments and a second segment of the second set of segments that corresponds to the first segment; determining one or more differences between the first image and the second image by comparing matched segments within the one or more pairs of matching segments; and generating an indication of differences comprising: a similarity score indicating a similarity between the first image and the second image, an image-based output comprising one or more visual indications of the one or more differences in one or both of the first image and the second image, and a text-based output comprising one or more text descriptions of the one or more differences between the first image and the second image.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a set of images that have differences between corresponding visual components of each image.

FIG. 2 depicts a process flowchart for determining differences between images.

FIG. 3 depicts a process flowchart for generating a similarity score.

FIG. 4 depicts various examples of similarity scores that can be generated for a set of images.

FIG. 5 depicts a process flowchart for determining segment differences between a set of images.

FIG. 6 depicts a process flowchart for determining image-based segment differences between a set of images using computer vision.

FIG. 7 depicts a process flowchart for determining text-based segment differences between a set of images using optical character recognition.

FIG. 8 depicts an example of an image-based output that includes visual indicators corresponding to differences identified in the set of images.

FIG. 9 depicts an example of a text-based output that includes a description and explanation of the differences identified in the set of images.

FIG. 10 depicts a method for detecting image differences.

FIG. 11 depicts an example processing system with which aspects of the present disclosure can be performed.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Content, such as text and graphics, can be structured in many different formats. For example, content can be structured as documents, like essays or reports, emails, webpages, user interfaces, images, videos, or other content formats. The content is usually arranged according to a particular content layout to facilitate organization and readability of a respective contact format and provide a pleasing aesthetic when viewing the content. In some instances, users need a way to detect differences between different versions of content layouts associated with a particular content format. Sometimes these differences are the result of a user directly editing the content layout, while other differences may be the result of changes to an underlying system used to generate or modify the content.

As one example, software applications undergo updates to add new features, fix bugs, improve performance, and maintain compatibility with evolving operating systems and computer hardware. Updates to the software application may change different user interfaces and/or outputs generated by the software application. Such changes can have cascading effects. For example, some downstream applications that use the generated outputs may rely on the generated outputs having a consistent content layout in order to function properly. If the content layout of the generated outputs is changed, the downstream application might malfunction when trying to use the generated outputs associated with the new version of the software application.

One approach to detecting interface and output differences associated with new versions of the software involves manual inspection by developers or end users. In this approach, individual developers compare the application's interfaces and outputs before and after the update and then document any observed differences. However, this manual approach suffers from several technical problems. In particular, manual inspection is inherently time-consuming and labor-intensive, particularly for applications with numerous interfaces and complex workflows. Additional technical problems relate to the fallibility of human-based inspections. Human inspectors may miss subtle differences or inconsistencies, especially when dealing with complex or dynamic content. Furthermore, human inspectors are also prone to subjectivity, meaning that inspections by different human inspectors can lead to inconsistent results across different inspections. Another technical problem with manual inspection is that this approach cannot be scaled effectively across increasingly complex applications and increasing frequency of updates to software applications.

To overcome some of the aforementioned technical problems, developers have attempted to employ automated difference detection, such as using pixel-by-pixel comparison between images of the interfaces and outputs associated with the old and new versions of the software interface. While this approach does provide more accurate difference detection and is more scalable than manual inspection, this pixel-by-pixel approach introduces its own technical problems.

Some technical problems associated with pixel-based comparison of images are based on the high sensitivity of pixel-by-pixel comparison. Because every pixel in each image is analyzed, pixel-based comparison can lead to reporting insignificant variations that do not affect functionality or that may not be recognizable to a human user. For example, a pixel-by-pixel comparison of images associated with different versions of a user interface in which a graphic has moved to a new location (e.g., a few pixel lengths to the right) could yield myriad detected differences. In such an example, a developer or user may only need to know that the specific graphic moved, and not that thousands of pixels in the rest of the image were affected by the slight movement of the graphic. Thus, when the pixel-based comparison reports such large numbers of differences, the results can become meaningless or difficult to interpret. Another technical problem occurs because the computational overhead of performing pixel-by-pixel comparison and processing the resulting differences can become prohibitive when analyzing software applications with high definition and/or large numbers of interfaces and outputs where millions of pixels may need to be analyzed.

While the above description is focused on detecting differences in images of software interfaces and corresponding outputs that may occur after software updates, the aforementioned technical problems can occur when employing either manual inspection or pixel-by-pixel comparison to detect differences in images of any type of content layout, such as documents, emails, advertisements, web pages, software application user interfaces, or other content layouts. Accordingly, the present disclosure describes aspects of an image difference detection system (herein “detection system”) that overcome many of the aforementioned technical problems associated with detecting differences in images.

In some aspects, the detection systems described herein are configured to output results of the differences at an abstract level and at a detailed level. At the abstract level, machine learning models are employed to generate one or more embeddings for each of the different images, where the one or more embeddings provide a type of summary of each image. The embedding(s) corresponding to each image can then be compared with each other to determine a similarity metric, such as a similarity score. The similarity score is configured to provide a simple, overall indication of how similar the images are.

At a detailed level, aspects of the detection systems described herein employ a segment-by-segment approach to detect differences between the images. In particular, the detection systems perform segmentation, segment matching, and segment comparison to identify differences between the images. In some aspects, computer vision is used to perform segmentation, segment matching, and segment comparison of image-based segments identified in the images. Additionally, or alternatively, optical character recognition (OCR) is used to perform segmentation, segment matching, and segment comparison of text-based segments identified in the images.

During the segmentation step, each image is divided into one or more segments. In some aspects, one or more segments relate to a specific visual component included in an image. Once the segmentation step is completed, the detection systems perform segment matching to determine which segments from the new image match which segments from the old image. In some aspects, a segment from the new image is determined to match a segment from the old image if they relate to a corresponding visual component included in both images. Additionally, segments can be determined to be matching based on similar text content, similar position of the segments, and other key point feature matching. Feature mapping After segment matching is performed, matched segments are then compared using various methods to identify differences between each pair of matching segments. These segment-based differences are then compiled to generate a detailed level of results indicating differences between the images.

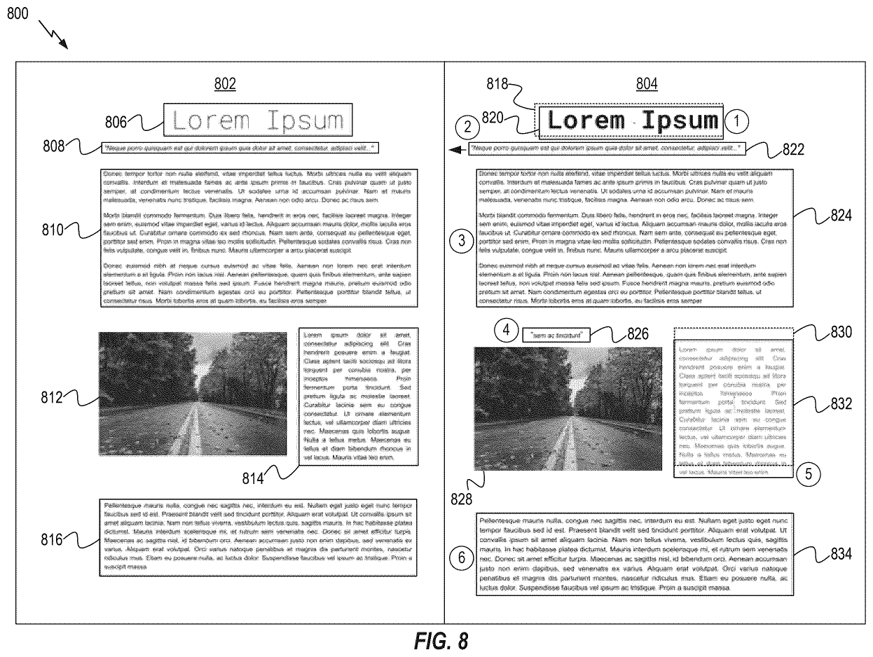

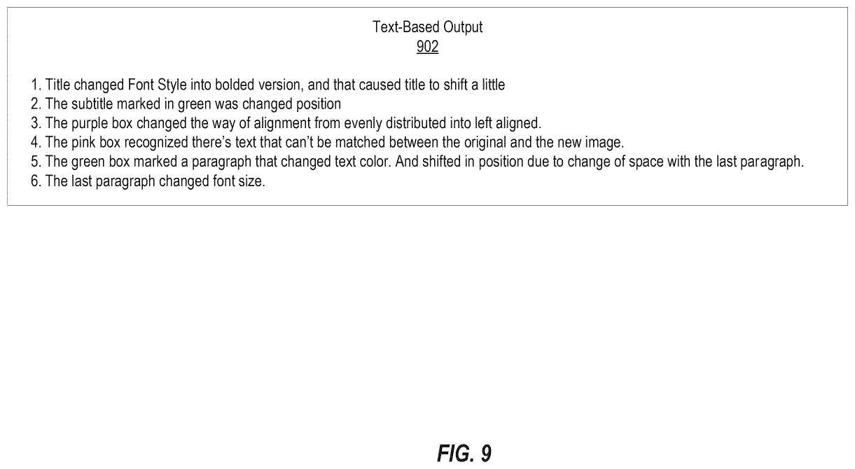

In some aspects, the detailed level of results includes an image-based output based on the detailed level of detected differences, and/or a text-based output based on the detailed level of detected differences. In some aspects, the image-based output may display a modified version of a second image that includes added visual indicators to indicate either how one or more segments are different from a first image. In some aspects, the image-based output displays a side-by-side comparison of the first image and the second image, such as in FIG. 8, with additional visual indicators in the second image indicating which segments are different. In some aspects, the text-based output may include text-based descriptions of the differences that were identified between the images. The text-based descriptions may include summary phrases, a few sentences, or longer paragraphs of descriptions to help a developer or user understand how and why the segments are different, as illustrated in FIG. 9. In some aspects, the detailed level of results includes a structured representation (such as JSON™) of the discovered differences that is formatted so that downstream applications are able to utilize the detailed level of results without additional processing.

Accordingly, the detection systems herein beneficially provide results indicating image differences at both an abstract and detailed level, as well as providing detailed results in different modalities, to facilitate a comprehensive and efficient understanding of the differences between the images. Thus, the detection systems described herein overcome many of the technical problems associated with image difference detection.

By providing both a high-level and detailed level of difference detection, the detection system results can be used by developers and end-users alike to streamline the difference detection process. For example, if the high-level similarity score is high, then it may not be necessary to review the detailed level of difference detection. Additionally, by providing a multi-modal result (e.g., an image-based output and text-based output), the results can be easily understood by end-users who may not have the technical knowledge of the developers. Users can then view the results and determine whether to switch to the new version of the software or if they have already switched to the new version, make changes to user settings in order to mitigate any unwanted differences that were detected in the new image.

As mentioned above, a change in position of one segment often causes cascading differences in subsequent segments. Beneficially, the detection systems are able to track all of the differences, including the dependencies between detected differences. In some aspects, the detection systems described herein are configured to only report differences in subsequent segments if their position offset or relative position to adjacent segments is changed, even if the absolute position within the image has changed. By tracking, filtering, and reporting differences in this manner, the resulting indication of differences is more meaningful and digestible by developers and users. That is, since the number of differences reported may be beneficially reduced, the differences that are reported are more relevant to the user experience, including the aesthetic and functionality of the user interface or its corresponding outputs.

In some aspects of the detection systems described herein, employing a segment-by-segment approach to detecting differences at the detailed level overcome the technical problem associated with performing a pixel-by-pixel comparison of entire images that is overly sensitive to insignificant differences. This is because the differences between the images can be tied to a particular visual component of the image, instead of an individual pixel. Additionally, this segment-by-segment approach also decreases the total number of indicated differences for a given set of images compared to the pixel-by-pixel approach for the same set of images, making the results easier to process downstream. By focusing on the more relevant differences, the detection systems described herein are able to reduce the amount of computational resources needed to detect differences in images and store the results.

### Example Image Difference Detection

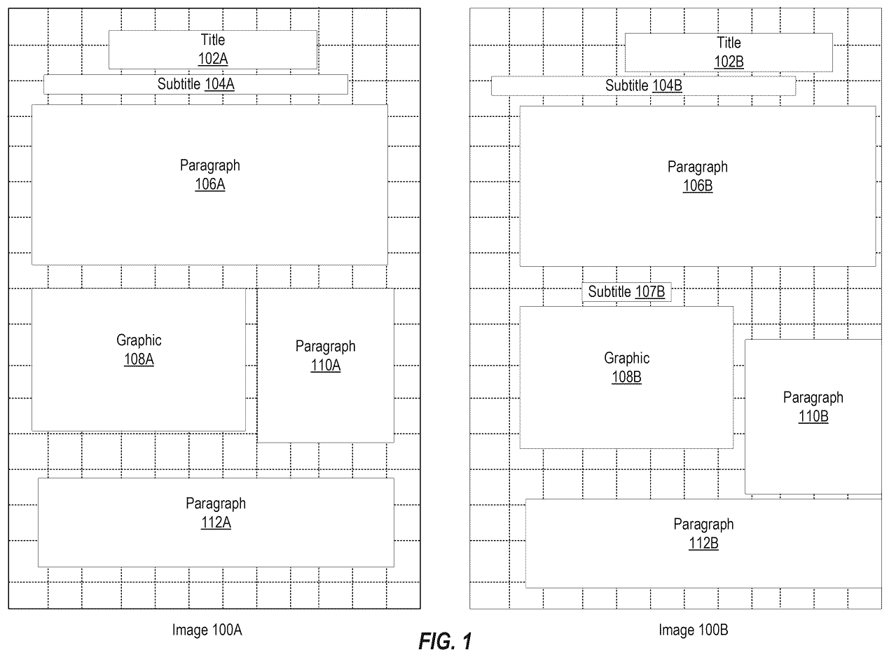

FIG. 1 depicts two different images, image 100A and image 100B. Notably, image 100A and image 100B may be images of any type of content layout, such as documents, emails, advertisements, web pages, software application user interfaces, or other content layouts. Some examples of visual components associated with different types of content layouts include titles, subtitles, paragraphs, graphics, photographs, pictures, illustrations, animations, videos, audio features, objects, shapes, selectable buttons, links, user input fields, output fields, or other visual components.

As shown in FIG. 1, image 100A is an image of content layout that includes a plurality of visual components, such as title 102A, subtitle 104A, paragraph 106A, graphic 108A, paragraph 110A, and paragraph 112A. Image 100B is a modified version of image 100A and includes a plurality of components, such as title 102B, subtitle 104B, paragraph 106B, graphic 108B, paragraph 110B, and paragraph 112B.

In one example, image 100A may be an image of an automated email that was generated by an automated email marketing software application configured to output automated emails based on a set of user settings and a set of system settings. Image 100B may an image of the automated email that was generated based on a different set of user settings, a different set of system settings, or a combination of both different user settings and different system settings of the automated email marketing software application. In some instances, the different set of system settings correspond to a new version of the software being used to generate the automated emails. The differences in the settings may cause differences in the various components of the email.

As illustrated, title 102B has shifted to the right when compared to the location of title 102A. Subtitle 104B has shifted to the left when compared to subtitle 104A. Paragraph 106B has shifted to the left when compared to paragraph 106A. Subtitle 107B is a new subtitle that was not included in image 100A. Graphic 108B is shifted to the right and shifted down when compared to graphic 108A. The position differences of the graphic 108B are caused by the addition of subtitle 107B in image B. Paragraph 110B has shifted down and to the right, also caused by the addition of subtitle 107B in image B. Paragraph 112B is shifted down and to the right when compared to paragraph 112B.

### Process Flowchart for Generating Results of Detected Image Differences

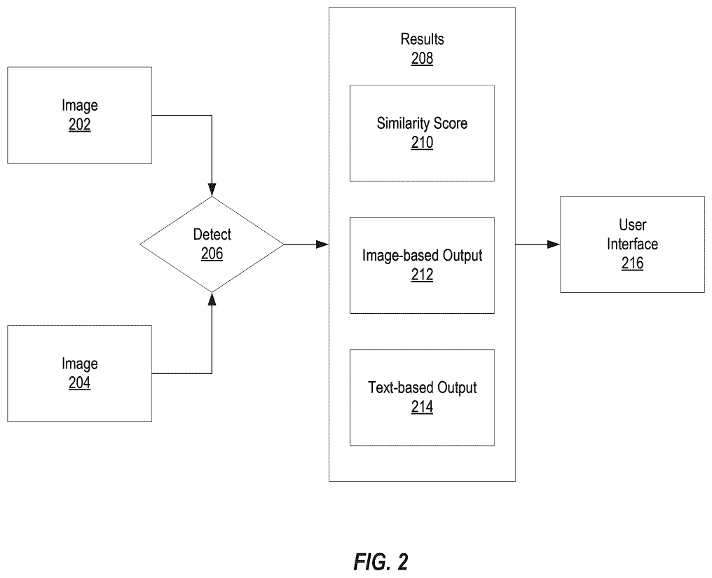

FIG. 2 depicts a process flowchart for generating results based on differences detected in a set of images.

Initially, image 202 and image 204 are compared with each other to detect differences at detect component 206 between the images. In some aspects, image 202 is comparable to image 100A of FIG. 1 and image 204 is comparable to image 100B of FIG. 1. After the differences between the images are detected, results 208 based on the identified differences are generated. In this example, results 208 include a similarity score 210, image-based output 212, and text-based output 214.

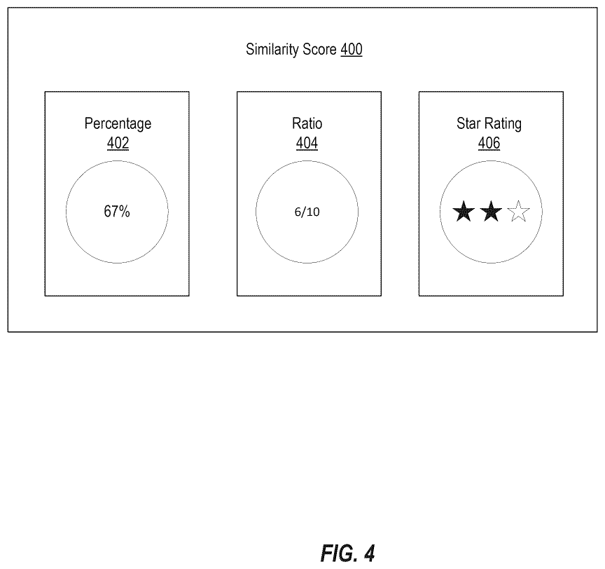

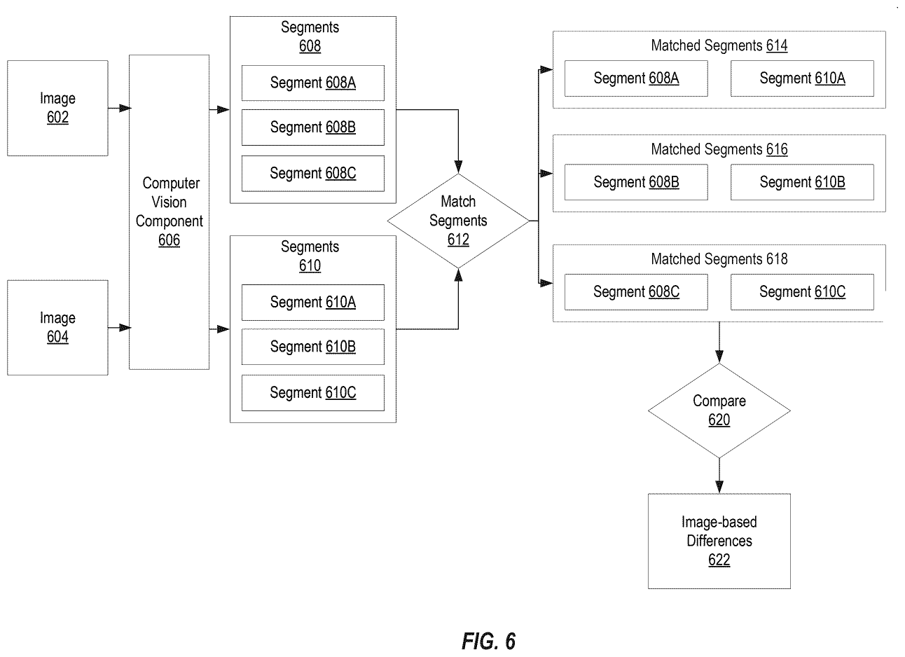

Similarity score 210 represents an overall metric of how similar the image 202 and image 204 are based on an abstract analysis of image 202 and image 204. Examples of similarity score 210 are illustrated in FIG. 4, and the process for generating similarity score 210 is described in further detail with respect to FIG. 6.

Image-based output 212 includes an indication of image-based differences between image 202 and image 204. Examples of image-based output 212 are illustrated in FIG. 4, and the process for generating image-based output 212 is described in further detail with respect to FIG. 8.

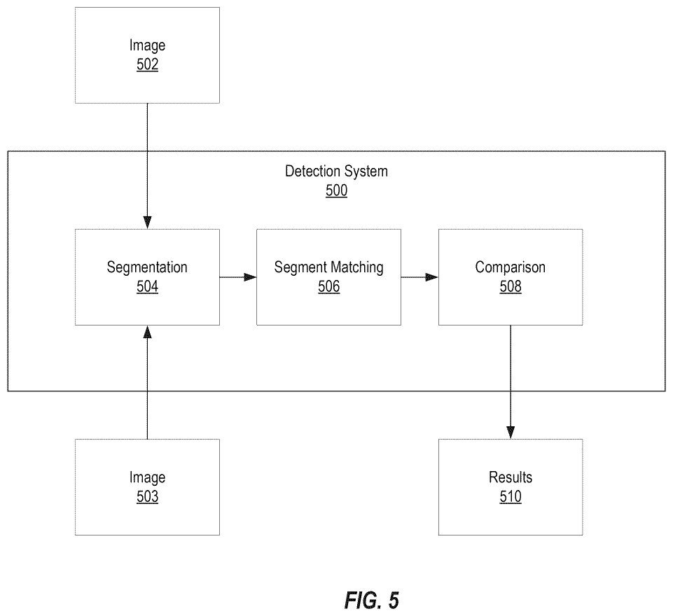

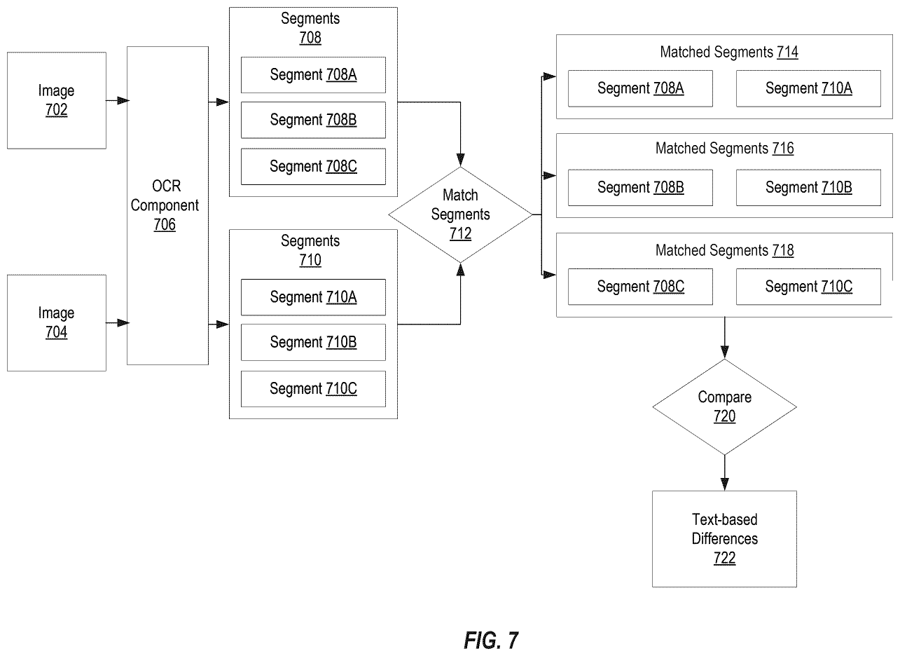

Text-based output 214 includes an indication of text-based differences between image 202 and image 204. Examples of text-based output 214 are illustrated in FIG. 5, and the process for generating text-based output 214 is described in further detail with respect to FIG. 7.

### Generating Similarity Scores

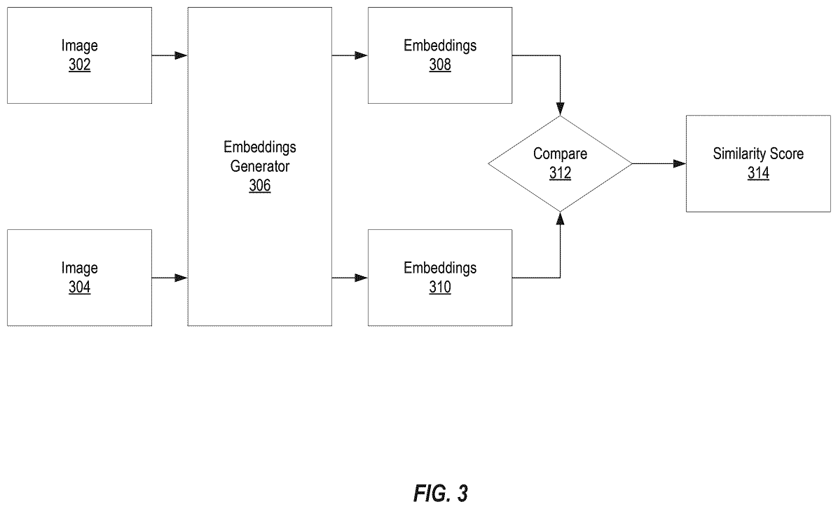

FIG. 3 depicts a process flowchart for generating a similarity score for a set of images. Image 302 and image 304 are provided to embeddings generator 306 which generates one or more embeddings 308 for image 302 and one or more embeddings 310 for image 304. Embeddings are a type of data representation where data is represented as vectors in an n-dimensional space, where n is often a large number, and where similar data are mapped to nearby points and semantic relationships between data are preserved. The one or more embeddings encode an overall summary of the original interface and an overall summary of the new interface. In some aspects, embeddings generator 306 is a machine learning model that is configured to generate embeddings for the set of images. Embeddings generator 306 may be configured as a pre-trained image embedding model or a domain-specific embedding model that can be trained and then used to generate the different sets of embeddings. In some instances, the embeddings generator 306 may be selected from a plurality of different machine learning models that are configured to generate embeddings for specific types of content. For example, one machine learning model may be better suited to perform detection of multi-color content versus black and white content in the set of images. In another example, one machine learning model might be better suited for photographic content versus text content. In some aspects, multiple models may be used to generate embeddings and perform the comparison, such that an average or median similarity score can be calculated based on a set of similarity scores generated by the different machine learning models.

The one or more embeddings 308 and one or more embeddings 310 are then compared at compare component 312 to generate a similarity score 314. In some aspects, similarity score 314 is calculated for the set of images based on comparing the one or more embeddings of each image. In some aspects, the similarity score 314 is calculated using a cosine similarity, a dot product similarity, or a Euclidean similarity. In some aspects, similarity score 314 is comparable to similarity score 210 of FIG. 2.

### Similarity Scores

FIG. 4 depicts various examples of similarity score 400 that can be generated for a set of images. As briefly mentioned above, the similarity score provides an abstract level description of how similar the images of the set of images are to each other. The similarity score is based on comparing one or more embeddings generated for one image with one or more embeddings generated for the other image. For example, if a first image is similar to a second image (e.g., there are few differences), the similarity score will be a high value on a bounded scale or scoring range. If the first image is different than the second image (e.g., there are many differences), the similarity score will be a low value on the bounded scale or scoring range.

In some aspects, similarity score 400, which is comparable to similarity score 210, can be configured as a percentage 402, a ratio 404, or a star rating 406. As illustrated, percentage 402 is a similarity score valued at 67%, where the percentage 402 is calculated based on a cosine similarity, Euclidean distance, Manhattan distance, or dot product comparison performed on the embeddings of the images. In some aspects, percentage 402 is converted to a ratio 404, such as 6/10. Ratio 404 may be any numeric ratio, such as a score out of 5, a score out of 10 (as illustrated in FIG. 4), a score out of 100, or another ratio that is equivalent to the percentage. As illustrated, star rating 406 is a visual indication of two out of three stars. In some aspects, star rating 406 may include any number of total maximum stars. For example, star rating 406 may include three out of five stars.

### Detailed-level Image Difference Detection

FIG. 5 depicts a process flowchart for determining differences between a set of images at a detailed-level. In some aspects, in order to provide a detailed analysis of detected image differences, detection system 500 is configured to segment the set of images and analyze differences in the images based on a segment-by-segment comparison. For example, image 502 and image 503 are segmented at segmentation 504 into a plurality of different segments. Each image includes various visual components and so, in some aspects, each segment corresponds to the specific visual component of the respective image.

In some aspects, each segment has a width, height, and an x-y coordinate position within a bounded area defined by the edges of the corresponding image. In some aspects, the x-y coordinate position corresponds to a corner of the segment, such as the top left corner, or a center of the segment. A segment may have a rectangular, circular, or custom shape, for example, based on the type and shape of visual component associated with the segment.

After segmenting each image, the detection systems then identify which segments from image 502 correspond to segments from image 503 at segment matching 506. The matched segments are then compared at comparison 508 to generate results 510, which include an indication of difference between the different matched segments. In some aspects, a segment within the original interface does not have a matching segment within the new interface, meaning that the new interface omitted a component found in the original interface. In other aspects, a segment within the new interface may not have a matching segment in the original interface, meaning the new interface include a new component that was not found in the original interface.

In some aspects, as described in further detail with respect to FIG. 6, the detection system is configured to generate image-based segments and identify differences between the image-based segments using computer vision. Alternatively, or additionally, as described in further detail with respect to FIG. 7, the detection system is configured to generated text-based segments and identify differences between the text-based segments using OCR.

### Detecting Detailed Image Differences With Computer Vision

FIG. 6 depicts a process flowchart for determining image-based segment differences between a set of images using computer vision. In particular, image 602 and image 604 are provided to computer vision component 606. Computer vision is a field of artificial intelligence that enables computers to understand and process visual information, similar to how humans interpret what they see with their eyes. Through deep learning techniques, computer vision systems, like computer vision component 606, can analyze digital images and videos to extract information based on visual data. Computer vision component 606 can detect image-based segments within each image and the identify differences between the images-based segments, including differences in segment positions, lighting and color, texture and patterns, shapes, geometries, and other differences in the images provided to computer vision component 606.

In this example, computer vision component 606 identified image-based segments in the set of images and generates a set of segments 608, including segment 608A, segment 608B, and segment 608C, for image 602. Computer vision component 606 also generates a set of segments 610, including segment 610A, segment 610B, and segment 610C, for image 604.

The detection system then identifies which segments in the set of segments 608 match which segments in the set of segments 610 at match segments 612. A segment within image 604 matches a segment within image 602 when the segments correspond to the same component of the interface, even when the component may appear differently in the new interface. For example, a photograph in image 604 may be identified as corresponding to a photograph in image 602, where the photograph changed from a multi-color photograph to a black and white version of the photograph while the photograph position and size remained the same.

After generating the different sets of segments, the detection system generates a plurality of matched segment sets, such as matched segments 614, matched segments 616, and matched segments 618. As illustrated, segment 608A matches segment 610A, segment 608B matches segment 610B, and segment 608C matches segment 610C. Each set of matched segments are then compared at compare component 620 to identify image-based differences 622. For example, segment 608A is compared with segment 610A, segment 608B is compared with segment 610B, and segment 608C is compared with segment 610C.

Thus, image-based differences 622 are identified based on comparing matched segments 614, matched segments 616, and matched segments 618. In some aspects, computer vision component 606 identifies differences in segment position, a pixel-by-pixel comparison within a pair of matched segments, key point feature matching, and/or affine transformations to detect differences in segment size or rotation. By limiting the pixel-by-pixel comparison to the region of the image defined by the particular segment, the detection system is able to identify detailed differences related to a particular component of the interface without having to analyze every single pixel in the entire image, thus saving significant compute.

These image-based differences 622 can then be included in image-based outputs, like image-based output 800 of FIG. 8, and text-based outputs, like text-based output 902 of FIG. 9, as part of the indication of differences between the set of images.

### Detecting Detailed Image Differences With Optical Character Recognition

FIG. 7 depicts a process flowchart for determining text-based segment differences between a set of images using OCR. OCR is a technology that identifies readable text in an underlying file and embeds the readable text in the file, such as words within a document file. This process works by analyzing the patterns of light and dark that make up individual characters of text and translating them into digital text that can be edited, searched, and stored electronically. OCR systems, like OCR component 706, can perform segmentation to isolate certain characters or portions of text, such as a title or paragraph, and use machine learning algorithms that can recognize different fonts, text formatting, handwriting styles, and even languages.

As shown in FIG. 7, image 702 and image 704 are provided to OCR component 706. OCR component 706 identifies text-based segments in the set of images and generates a set of segments 708, including segment 708A, segment 708B, and segment 708C, for image 702. OCR component 706 also generates a set of segments 710, including segment 710A, segment 710B, and segment 710C, for image 704.

The detection system then identifies which segments in the set of segments 708 match which segments in the set of segments 710 at match segments 712. A segment within image 704 matches a segment within image 702 when the segments correspond to a corresponding visual component of the images, even when the corresponding visual component may appear differently in one of the images. For example, a title in image 704 may be identified as corresponding to a title in image 702, even though a word in the title changed, but the font size, relative order with respect to other components, and typeface style of the title text remained the same.

After generating the different sets of segments, the detection system generates a plurality of matched segment sets, such as matched segments 714, matched segments 716, and matched segments 718. As illustrated, segment 708A matches segment 710A, segment 708B matches segment 710B, and segment 708C matches segment 710C. Each set of matched segments are then compared at compare component 720 to identify text-based differences 722. For example, segment 708A is compared with segment 710A, segment 708B is compared with segment 710B, and segment 708C is compared with segment 710C.

Thus, text-based differences 722 are identified based on comparing matched segments 714, matched segments 716, and matched segments 718. In some aspects, OCR component 706 identifies differences between the images based on differences in segment position, based on fuzzy text comparisons, and/or pixel-by-pixel comparison between a pair of matched segments. These text-based differences 722 can then be included image-based outputs and text-based outputs that provide a user with different modalities by which to understand the differences in the images.

In some aspects, the detection system includes a pre-trained multi-modal generative model that is configured to receive a set of images as input and perform interface difference detection. In such aspects, the model is configured to analyze the differences between the images and generate the indication of differences comprising one or more of: the similarity score, the image-based output, and the text-based output, as described herein. The model may be prompted to generate the text-based output in a specific format, such as JSON™ or other structured textual format. In some instances, the prompt is formatted based on the type of content of the set of images, the type of content layout of the set of images, and/or type of model being used to determine the differences between the images.

### Image-Based Outputs

FIG. 8 depicts an example of image-based output that includes visual indicators corresponding to differences identified in the set of images. In some aspects, image-based output 800 includes visual indicators of both image-based differences identified using computer vision, as described in more detail with respect to FIG. 8, and text-based differences identified using OCR, as described in more detail with respect to FIG. 7. For example, image-based output 800 may include a visual indicator that represents a position change of a graphic, such as photograph, that was identified based on computer vision. As another example, image-based output 800 may include a visual indicator of a letter change, like a change from a capital letter to a non-capital letter, in a title that was identified using OCR.

As shown in FIG. 8, the image-based output 800 depicts a set of images. In some aspects, each image is of a different version of a document. Image 802 includes a plurality of segments, including title 806, subtitle 808, paragraph 810, photograph 812, paragraph 814, and paragraph 816, associated with a first version of the document. Image 804 includes a plurality of segments, including title 820, subtitle 822, paragraph 824, subtitle 826, photograph 828, paragraph 832, and paragraph 834, associated with a second version of the document.

During a segment matching process (described in more detail with respect to FIGS. 5-9), title 820 is found to match title 806, subtitle 822 is found to match subtitle 808, paragraph 824 is found to match paragraph 810, photograph 828 is found to match photograph 812, paragraph 832 is found to match paragraph 814, and paragraph 834 is found to match paragraph 816. Segments are determined to be matching if they relate to the same component, even if the segment has incurred differences in the new version. For example, title 820 matches title 806 because they both relate to the component comprising the title “Lorem Ipsum.” Notably, subtitle 826 in image 804 does not have a matching segment in image 802 because image 802 does not have any text above photograph 812.

Based on identifying the matching segments between image 802 and image 804, the detection system is able to identify the differences between each pair of matching segments and identify differences between the images based on non-matched segments. Image-based output 800 indicates at least six differences between image 802 and image 804. For example, a first difference (1) relates to the title segment, where title 820 is shifted in location from where matching title 806 was located in image 802. Additionally, title 820 is now bolded, whereas title 806 was formatted as regular un-bolded typeface. In order to visually indicate the shift in position between title 806 and title 820, dotted segment 818 is displayed where title 806 was previously located within image 802.

A second difference (2) relates to subtitle 822, which is shifted to the left as compared to subtitle 808. The shift is indicated by an arrow pointing to the left of subtitle 822. A third difference (3) relates to paragraph 824 because the text of paragraph of 824 is changed to a left-justified as compared to the full-justified text of paragraph 810. A fourth difference (4) relates to subtitle 826 which does not have a matching segment, meaning that it is a new addition to the document. A fifth difference (5) relates to paragraph 832, which has shifted downward as compared to paragraph 814. To indicate the position shift, dotted segment 830 is displayed where paragraph 814 was originally located in image 802. A sixth difference (6) relates to paragraph 834 because the text of paragraph 834 has changed font size as compared to the text of paragraph 816.

In some aspects, image-based output 800 is configured to display differences that would be visible to the human eye, such as bolded text and change of location of title 820. Thus, in some aspects, image-based output 800 does not visually indicate every difference between the images, but rather focuses on the differences that affect the user experience with the content layout shown in the image. For example, while photograph 828 and paragraph 834 both shifted downward in their absolute positions as compared to their matching segments in image 802, their relative positions to adjacent segments remained the same. As illustrated, a top of photograph 828 remains aligned with a top of paragraph 832 and the white space between paragraph 834 and paragraph 832 remains the same as compared to the white space between paragraph 816 and paragraph 814. Thus, while these are differences that the detection system is configured to detect, such differences may not be visually indicated in the image-based output 800 because they may not be noticeable to the human eye, thereby not affecting the user experience with the document. A pixel-by-pixel comparison of the entire images would flag this type of difference, which may not be useful or meaningful to the user, resulting in a degraded user experience and wasted computational resources associated with detecting and reporting this type of difference.

Image-based output 800 may include any number of different visual indicators that help to indicate to a user viewing the image-based output 800 which segments are different. For example, position differences may be indicated by a dotted segment in place of where the matching segment would have been located in the previous version or an arrow may indicate the shift in direction (especially if the segment has shifted in only one direction). Lines may be configured as dotted, dashed, weighted, or with different colors to distinguish between different segments. Different text may be highlighted. Additionally, each difference may be indicated with a numerical identifier. In some aspects, only segments that have a difference from their matching segment are boxed. In some aspects, a user may hover over a particular segment and view an animation of how the segment changed from its original version in image 802 to its new version in image 804.

In this manner, by providing image-based output 800 to a user, the detection systems described herein allow users to quickly and efficiently identify differences in images without having to perform a manual inspection or review excessive and potentially irrelevant differences that may be generated by a pixel-by-pixel comparison of the same images.

### Text-based Outputs

FIG. 9 depicts an example of text-based output that describes the differences identified in the set of images, such as image 802 and image 804 of FIG. 8. For example, text-based output 902 includes a listing of descriptions formatted in prose that describe various differences between image 802 and image 804. In some aspects, text-based output 902 is comparable to text-based output 214 of FIG. 2. In some aspects, text-based output 902 describes various differences, including image-based differences identified using computer vision, as described in more detail with respect to FIG. 6, and text-based differences identified using OCR, as described in more detail with respect to FIG. 7. For example, text-based output 902 may include a text-based description that describes a position change of a graphic, such as photograph, that was identified based on computer vision. As another example, text-based output 902 may include a text-based description that describes a change from a capital letter to a non-capital letter in a title that was identified using OCR.

As illustrated, text-based output 902 may include one or more text-based descriptions of differences between two different images of an automated email. In some aspects, a text-based description, which is generated by the detection systems described herein, includes one or more sentences that describe the differences between the images. In some aspects, text-based descriptions can be tuned to different granularities, from brief summaries such as phrases to detailed paragraphs. A text-based description may describe what the difference is, what component the difference is related to, a source of the difference (or an explanation of why the difference occurred), and/or a description of how the difference was visually indicated in image-based output corresponding to the same set of images described in text-based output 902.

As illustrated, a first difference (1) relates to a title, where the font style was changed to a bolded version. This difference is determined to be the source of another difference between the images, where the font style change caused the title to shift. In some aspects, the first difference and corresponding additional difference are text-based descriptions of image-based difference (1) of FIG. 8. A second difference (2) relates to a subtitle, where the position of the subtitle changed in the new image. In some aspects, the second difference is a text-based description of image-based difference (2) of FIG. 8. Text-based output 902 includes a third difference, where a set of text had a change of alignment from evenly distributed in the original image to left aligned in the new image. In some aspects, the third difference is a text-based description of image-based difference (3) of FIG. 8.

A fourth difference relates to a set of text that cannot be matched between the original image and the new image. Such a difference can arise where the new image includes new text in a new location that was not included in original image or when text has been modified in the new image from text found in the original image. In some aspects, the fourth difference of text-based output 902 is a text-based description of image-based difference (4) of FIG. 8. A fifth difference describes that the text of a paragraph changed color. Additionally, the same text changed position. This additional difference of the paragraph text had a source, namely: the text shifted in position due to a change in the space of another adjacent paragraph. In some aspects, the fifth difference of text-based output 902 is a text-based description of image-based difference (5) of FIG. 8. A sixth difference illustrated in FIG. 8, describes that the text of a paragraph changed font size in the new image. In some aspects, the sixth difference of text-based output 902 is a text-based description of image-based difference (6) of FIG. 8.

### Example Method for Detecting Interface Differences

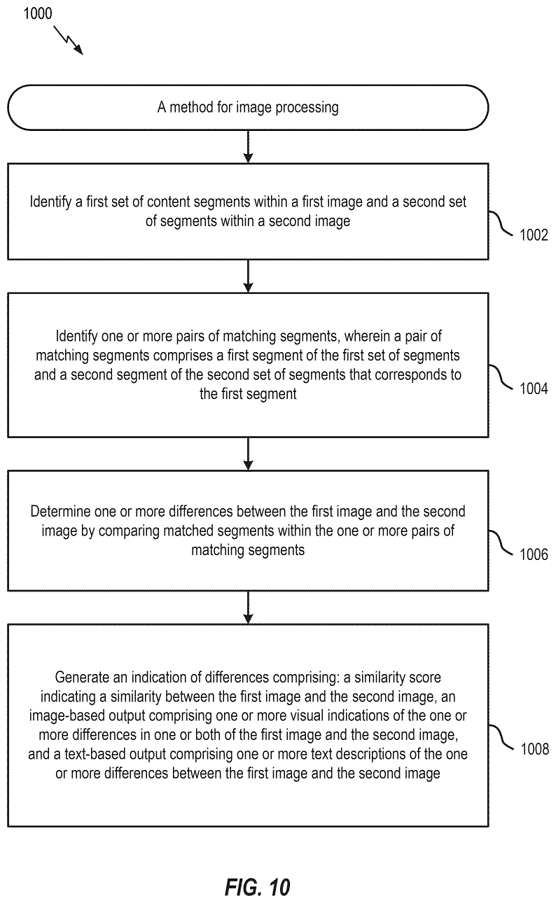

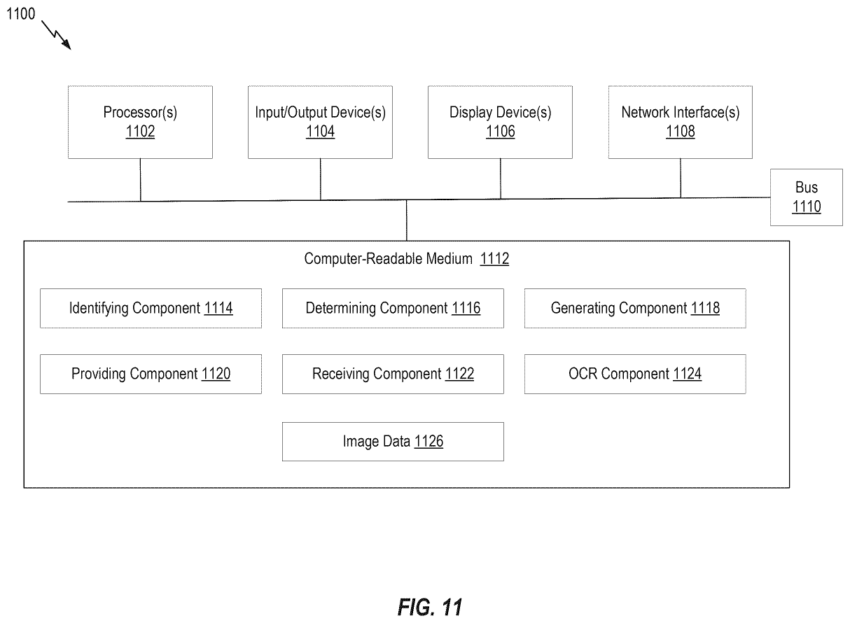

FIG. 10 depicts an example of a method 1000 for detecting interface differences. In one aspect, method 1000 can be implemented by the processing system 1100 of FIG. 11.

Method 1000 starts at block 1002 with identifying a first set of segments within a first image and a second set of segments within a second image. In some aspects, block 1002 is performed by identifying component 1114 of FIG. 11. For example, identifying component 1114 may identify a first set of segments within image 502 of FIG. 5 and a second set of segments within image 503 of FIG. 5 at segmentation 504 of FIG. 5.

Method 1000 continues to block 1004 with identifying one or more pairs of matching segments, wherein a pair of matching segments comprises a first segment of the first set of segments and a second segment of the second set of segments that corresponds to the first segment. In some aspects, block 1004 is performed by identifying component 1114 of FIG. 11. For example, identifying component 1114 may identifying one or more pairs of matching segments at segment matching 506 of FIG. 5.

Method 1000 continues to block 1006 with determining one or more differences between the first image and the second image by comparing matched segments within the one or more pairs of matching segments. In some aspects, block 1006 is performed by determining component 1116 of FIG. 11. For example, determining component 1116 may determine one or more differences between image 502 and image 503 by comparing matched segments at comparison 508 of FIG. 5.

Method 1000 continues to block 1008 with generating an indication of differences comprising: a similarity score indicating a similarity between the first image and the second image, an image-based output comprising one or more visual indications of the one or more differences in one or both of the first image and the second image, and a text-based output comprising one or more text descriptions of the one or more differences between the first image and the second image. In some aspects, block 1008 is performed by generating component 1118 of FIG. 11. For example, generating component 1118 may generate results 510 of FIG. 5 comprising an indication of differences. In some aspects, results 510 is comparable to results 208 and comprises similarity score 210, image-based output 212, and text-based output 214.

In some aspects, method 1000 includes aspects for performing computer vision analysis to identify image-based differences. In some aspects, method 1000 includes providing the first image and the second image to a computer vision component configured to identify image-based segments in images. Based on providing the first image and second image to the computer vision component, method 1000 includes receiving, from the computer vision component, a first subset of image-based segments for the first image and a second subset of image-based segments for the second image. In such aspects, the first subset of image-based segments is included in the first set of segments and the second subset of image-based segments is included in the second set of segments.

In some aspects, providing component 1120 of FIG. 11 provides image 602 of FIG. 6 and image 604 of FIG. 6 to computer vision component 606 of FIG. 6. Receiving component 1122 of FIG. 11 receives, from computer vision component 606, a first subset of image-based segments, such as segment 608A, segments 608B, and segment 608C of FIG. 6 for image 602, and a second subset of image-based segments, such as segment 610A, segment 610B, and segment 610C of FIG. 6 for image 604.

In some aspects, method 1000 includes aspects for performing OCR to identify text-based differences. In some aspects, method 1000 includes providing the first image and the second image to an OCR component configured to identify text-based segments in images. Based on providing the first image and the second image to the OCR component, method 1000 includes receiving, from the OCR component, a first subset of text-based segments for the first image and a second subset of text-based segments for the second image. In such aspects, the first subset of text-based segments is included in the first set of segments and the second subset of text-based segments is included in the second set of segments.

In some aspects, providing component 1120 of FIG. 11 provides image 702 of FIG. 7 and image 704 of FIG. 7 to OCR component 706 of FIG. 7. Receiving component 1122 of FIG. 11 receives, from OCR component 706, a first subset of image-based segments, such as segment 708A, segments 708B, and segment 708C of FIG. 7 for image 702, and a second subset of image-based segments, such as segment 710A, segment 710B, and segment 710C of FIG. 7 for image 704.

In some aspects, the similarity score is generated by: generating a first set of embeddings for the first image and a second set of embeddings for the second image; and generating the similarity score based on comparing the first set of embeddings with the second set of embeddings. For example, generating component 1118 of FIG. 11 may generate embeddings 308 of FIG. 3 for image 302 of FIG. 3 and embeddings 310 of FIG. 3 for image 304 of FIG. 3. Based on comparing embeddings 308 and embeddings 310 at compare component 312 of FIG. 3, generating component 1118 may generate similarity score 314.

In some aspects, generating the similarity score is based on calculating one or more of: a cosine similarity, a dot product similarity, or Euclidean similarity.

In some aspects, generating the first set of embeddings and the second set of embeddings comprises providing the first image and the second image as input to a machine learning model, such as embeddings generator 306 of FIG. 3, configured to generate image embeddings.

In some aspects, the one or more differences between the first image and the second image comprises one or more of: a segment location change, a segment size change, a font change, a typeface change, a text-alignment change, or a word change. Some examples of the one or more differences are illustrated in FIG. 8.

In some aspects, the one or more visual indications comprises one or more of: a first box outlining a segment in the second image that is different than a corresponding segment in the first image, an arrow pointing to the first box from a second box outlining where the corresponding segment would have appeared unchanged in the second image, or a highlight of a section of text that is different in the second image than a corresponding section of text in the first image. Some examples of the one or more visual indications are illustrated in FIG. 8.

In some aspects, the text-based output further comprises one or more sources of the one or more differences presented themselves in the second image. For example, text-based output 902 of FIG. 9 describes a first difference in which the “Title changed Font Style into bolded version, and that caused title to shift a little.” Accordingly, there are two differences, the font style change and the title location shift, where the font style change is the source of the title location shift.

In some aspects, method 1000 further includes providing the indication of differences to a user interface that is configured to display the indication of differences to a user. For example, providing component 1120 of FIG. 11 may provide results 208 of FIG. 2 to user interface 216 of FIG. 2.

By employing a segment-by-segment approach instead of a pixel-by-pixel approach to detecting differences, method 1000 overcomes the technical problem associated with pixel-by-pixel comparison which is overly sensitive to insignificant differences. This is because the differences can be tied to a segment of the image instead of an individual pixel. Additionally, method 1000 decreases the total number of differences that are reported as compared to a pixel-by-pixel approach, making the results easier to interpret. Thus, users are able to identify the most relevant differences between the images quickly and efficiently without having to review thousands and thousands of pixel differences. By focusing on the more relevant differences, method 1000 is able to reduce the amount of computational resources needed to process the images and store the results.

By providing both a high-level and detailed level of difference detection, method 1000 be used by developers and end-users alike to streamline the difference detection process. For example, if the high-level similarity score is high, then it may not be necessary to review the detailed level of difference detection. Additionally, by providing a multi-modal result (e.g., an image-based output and text-based output), the results from method 1000 can be easily understood by end-users who may not have the technical knowledge of the developers. Furthermore, method 1000 achieves improved scalability because method 1000 can be employed automatically and can also be used at different stages of the update process, including during development and post-deployment, using reduced computational resources as compared to a pixel-by-pixel comparison of the entire images.

Note that FIG. 10 is just one example of a method, and other methods including fewer, additional, or alternative operations are possible consistent with this disclosure.

### Example Processing System for Detecting Interface Differences

FIG. 11 depicts an example of a processing system 1100 configured to perform various aspects described herein, including, for example, method 1000 as described above with respect to FIG. 10.

Processing system 1100 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1100 includes one or more processor(s) 1102, one or more input/output device(s) 1104, one or more display device(s) 1106, one or more network interface(s) 1108 through which processing system 1100 is connected to one or more networks (e.g., a local network, an intranet, the Internet, or any other group of processing systems communicatively connected to each other), and computer-readable medium 1112. In the depicted example, the aforementioned components are coupled by a bus 1110, which may generally be configured for data exchange amongst the components. Bus 1110 may be representative of multiple buses, while only one is depicted for simplicity.

Processor(s) 1102 are generally configured to retrieve and execute instructions stored in one or more memories, including local memories like computer-readable medium 1112, as well as remote memories and data stores. Similarly, processor(s) 1102 are configured to store application data residing in local memories like the computer-readable medium 1112, as well as remote memories and data stores. More generally, bus 1110 is configured to transmit programming instructions and application data among the processor(s) 1102, display device(s) 1106, network interface(s) 1108, and/or computer-readable medium 1112. In certain embodiments, processor(s) 1102 are representative of a one or more central processing units (CPUs), graphics processing unit (GPUs), tensor processing unit (TPUs), accelerators, and other processing devices.

Input/output device(s) 1104 may include any device, mechanism, system, interactive display, and/or various other hardware and software components for communicating information between processing system 1100 and a user of processing system 1100. For example, input/output device(s) 1104 may include input hardware, such as a keyboard, touch screen, button, microphone, speaker, and/or other device for receiving inputs from the user and sending outputs to the user.

Display device(s) 1106 may generally include any sort of device configured to display data, information, graphics, user interface elements, and the like to a user. For example, display device(s) 1106 may include internal and external displays such as an internal display of a tablet computer or an external display for a server computer or a projector. Display device(s) 1106 may further include displays for devices, such as augmented, virtual, and/or extended reality devices. In various embodiments, display device(s) 1106 may be configured to display a graphical user interface.

Network interface(s) 1108 provide processing system 1100 with access to external networks and thereby to external processing systems. Network interface(s) 1108 can generally be any hardware and/or software capable of transmitting and/or receiving data via a wired or wireless network connection. Accordingly, network interface(s) 1108 can include a communication transceiver for sending and/or receiving any wired and/or wireless communication.

Computer-readable medium 1112 may be a volatile memory, such as a random-access memory (RAM), or a nonvolatile memory, such as nonvolatile random-access memory (NVRAM), or the like. In this example, computer-readable medium 1112 includes identifying component 1114, determining component 1116, generating component 1118, providing component 1120, receiving component 1122, OCR component 1124, and image data 1126. Processing of the components 1114-1124 may enable and cause the processing system 1100 to perform the method 1000 described with respect to FIG. 10, or any aspect related to it.

In certain embodiments, identifying component 1114 is configured to identify a first set of segments within a first image and a second set of segments within a second image (e.g., image data 1126), such as described in block 1002 of FIG. 10. In certain embodiments, identifying component 1114 is configured to identify one or more pairs of matching segments (e.g., image data 1126), wherein a pair of matching segments comprises a first segment of the first set of segments and a second segment of the second set of segments that corresponds to the first segment, such as described in block 1004 of FIG. 10. In certain embodiments, determining component 1116 is configured to determine one or more differences between the first image and the second image by comparing matched segments within the one or more pairs of matching segments, such as described in block 1006 of FIG. 10. In certain embodiments, generating component 1118 is configured to generate an indication of differences comprising: a similarity score indicating a similarity between the first image and the second image; an image-based output comprising one or more visual indications of the one or more differences in one or both of the first image and the second image; and a text-based output comprising one or more text descriptions of the one or more differences between the first image and the second image, such as described in block 1008 of FIG. 10.

In certain embodiments, providing component 1120 is configured to provide the first image and the second image to OCR component 1124 configured to identify text-based segments in images. In certain embodiments, receiving component 1122 is configured to receive, from OCR component 1124, a first subset of text-based segments for the first image and a second subset of text-based segments for the second image, wherein the first subset of text-based segments is included in the first set of segments and the second subset of text-based segments is included in the second set of segments.

Note that FIG. 11 is just one example of a processing system consistent with aspects described herein, and other processing systems having additional, alternative, or fewer components are possible consistent with this disclosure.

### Example Clauses

Implementation examples are described in the following numbered clauses:

Clause 1: A method, comprising: identifying a first set of segments within a first image and a second set of segments within a second image; identifying one or more pairs of matching segments, wherein a pair of matching segments comprises a first segment of the first set of segments and a second segment of the second set of segments that corresponds to the first segment; determining one or more differences between the first image and the second image by comparing matched segments within the one or more pairs of matching segments; and generating an indication of differences comprising: a similarity score indicating a similarity between the first image and the second image, an image-based output comprising one or more visual indications of the one or more differences in one or both of the first image and the second image, and a text-based output comprising one or more text descriptions of the one or more differences between the first image and the second image.

Clause 2: The method of Clause 1, wherein identifying the first set of segments within the first image and the second set of segments within the second image comprises: providing the first image and the second image to a computer vision component configured to identify image-based segments in images; and receiving, from the computer vision component, a first subset of image-based segments for the first image and a second subset of image-based segments for the second image, wherein the first subset of image-based segments is included in the first set of segments and the second subset of image-based segments is included in the second set of segments.

Clause 3: The method of any one of Clauses 1-2, wherein identifying the first set of segments within the first image and the second set of segments within the second image comprises: providing the first image and the second image to an OCR component configured to identify text-based segments in images; and receiving, from the OCR component, a first subset of text-based segments for the first image and a second subset of text-based segments for the second image, wherein the first subset of text-based segments is included in the first set of segments and the second subset of text-based segments is included in the second set of segments.

Clause 4: The method of any one of Clauses 1-3, wherein the similarity score is generated by: generating a first set of embeddings for the first image and a second set of embeddings for the second image; and generating the similarity score based on comparing the first set of embeddings with the second set of embeddings.

Clause 5: The method of Clause 4, wherein generating the similarity score is based on calculating one or more of: a cosine similarity, a dot product similarity, or Euclidean similarity.

Clause 6: The method of Clause 4, wherein generating the first set of embeddings and the second set of embeddings comprises providing the first image and the second image as input to a machine learning model configured to generate image embeddings.

Clause 7: The method of any one of Clauses 1-6, wherein the one or more differences between the first image and the second image comprises one or more of: a segment location change, a segment size change, a font change, a typeface change, a text-alignment change, or a word change.

Clause 8: The method of any one of Clauses 1-7, wherein the one or more visual indications comprises one or more of: a first box outlining a segment in the second image that is different than a corresponding segment in the first image, an arrow pointing to the first box from a second box outlining where the corresponding segment would have appeared unchanged in the second image, or a highlight of a section of text that is different in the second image than a corresponding section of text in the first image.

Clause 9: The method of any one of Clauses 1-8, wherein the text-based output further comprises one or more sources of the one or more differences presented themselves in the second image.

Clause 10: The method of any one of Clauses 1-9, further comprising providing the indication of differences to a user interface that is configured to display the indication of differences to a user.

Clause 11: A processing system, comprising: memory comprising computer-executable instructions; and one or more processors configured to execute the computer-executable instructions and cause the processing system to perform a method in accordance with any one of Clauses 1-10.

Clause 12: A processing system, comprising means for performing a method in accordance with any one of Clauses 1-10.

Clause 13: A non-transitory computer-readable medium storing program code for causing a processing system to perform the steps of any one of Clauses 1-10.

Clause 14: A computer program product embodied on a computer-readable storage medium comprising code for performing a method in accordance with any one of Clauses 1-10.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
identifying a first set of segments within a first image and a second set of segments within a second image;
identifying one or more pairs of matching segments, wherein a pair of matching segments comprises a first segment of the first set of segments and a second segment of the second set of segments that corresponds to the first segment;
determining one or more differences between the first image and the second image by comparing matched segments within the one or more pairs of matching segments; and
generating an indication of differences comprising:
a similarity score indicating a similarity between the first image and the second image;
an image-based output comprising one or more visual indications of the one or more differences in one or both of the first image and the second image; and
a text-based output comprising one or more text descriptions of the one or more differences between the first image and the second image.

2. The method of claim 1, wherein identifying the first set of segments within the first image and the second set of segments within the second image comprises:
providing the first image and the second image to a computer vision component configured to identify image-based segments in images; and
receiving, from the computer vision component, a first subset of image-based segments for the first image and a second subset of image-based segments for the second image, wherein the first subset of image-based segments is included in the first set of segments and the second subset of image-based segments is included in the second set of segments.

3. The method of claim 1, wherein identifying the first set of segments within the first image and the second set of segments within the second image comprises:
providing the first image and the second image to an optical character recognition (OCR) component configured to identify text-based segments in images; and
receiving, from the OCR component, a first subset of text-based segments for the first image and a second subset of text-based segments for the second image, wherein the first subset of text-based segments is included in the first set of segments and the second subset of text-based segments is included in the second set of segments.

4. The method of claim 1, wherein the similarity score is generated by:
generating a first set of embeddings for the first image and a second set of embeddings for the second image; and
generating the similarity score based on comparing the first set of embeddings with the second set of embeddings.

5. The method of claim 4, wherein generating the similarity score is based on calculating one or more of: a cosine similarity, a dot product similarity, or Euclidean similarity.

6. The method of claim 4, wherein generating the first set of embeddings and the second set of embeddings comprises providing the first image and the second image as input to a machine learning model configured to generate image embeddings.

7. The method of claim 1, wherein the one or more differences between the first image and the second image comprises one or more of: a segment location change, a segment size change, a font change, a typeface change, a text-alignment change, or a word change.

8. The method of claim 1, wherein the one or more visual indications comprises one or more of: a first box outlining a segment in the second image that is different than a corresponding segment in the first image, an arrow pointing to the first box from a second box outlining where the corresponding segment would have appeared unchanged in the second image, or a highlight of a section of text that is different in the second image than a corresponding section of text in the first image.

9. The method of claim 1, wherein the text-based output further comprises one or more sources of the one or more differences presented themselves in the second image.

10. The method of claim 1, further comprising providing the indication of differences to a user interface that is configured to display the indication of differences to a user.

11. A processing system, comprising: memory comprising computer-executable instructions; and one or more processors configured to execute the computer-executable instructions and cause the processing system to:
identify a first set of segments within a first image and a second set of segments within a second image;
identify one or more pairs of matching segments, wherein a pair of matching segments comprises a first segment of the first set of segments and a second segment of the second set of segments that corresponds to the first segment;
determine one or more differences between the first image and the second image by comparing matched segments within the one or more pairs of matching segments; and
generate an indication of differences comprising:
a similarity score indicating a similarity between the first image and the second image;
an image-based output comprising one or more visual indications of the one or more differences in one or both of the first image and the second image; and
a text-based output comprising one or more text descriptions of the one or more differences between the first image and the second image.

12. The processing system of claim 11, wherein to cause the processing system to identify the first set of segments within the first image and the second set of segments within the second image, the one or more processors are configured to execute the computer-executable instructions and cause the processing system to:
provide the first image and the second image to a computer vision component configured to identify image-based segments in images; and
receive, from the computer vision component, a first subset of image-based segments for the first image and a second subset of image-based segments for the second image, wherein the first subset of image-based segments is included in the first set of segments and the second subset of image-based segments is included in the second set of segments.

13. The processing system of claim 11, wherein to cause the processing system to identify the first set of segments within the first image and the second set of segments within the second image, the one or more processors are configured to execute the computer-executable instructions and cause the processing system to:
provide the first image and the second image to an optical character recognition (OCR) component configured to identify text-based segments in images; and
receive, from the OCR component, a first subset of text-based segments for the first image and a second subset of text-based segments for the second image, wherein the first subset of text-based segments is included in the first set of segments and the second subset of text-based segments is included in the second set of segments.

14. The processing system of claim 11, wherein the similarity score is generated by:
generating a first set of embeddings for the first image and a second set of embeddings for the second image; and
generating the similarity score based on comparing the first set of embeddings with the second set of embeddings.

15. The processing system of claim 14, wherein generating the similarity score is based on calculating one or more of: a cosine similarity, a dot product similarity, or Euclidean similarity.

16. The processing system of claim 14, wherein generating the first set of embeddings and the second set of embeddings comprises providing the first image and the second image as input to a machine learning model configured to generate image embeddings.

17. The processing system of claim 11, wherein the one or more differences between the first image and the second image comprises one or more of: a segment location change, a segment size change, a font change, a typeface change, a text-alignment change, or a word change.

18. The processing system of claim 11, wherein the one or more visual indications comprises one or more of: a first box outlining a segment in the second image that is different than a corresponding segment in the first image, an arrow pointing to the first box from a second box outlining where the corresponding segment would have appeared unchanged in the second image, or a highlight of a section of text that is different in the second image than a corresponding section of text in the first image.

19. The processing system of claim 11, wherein the text-based output further comprises one or more sources of the one or more differences presented themselves in the second image.

20. The processing system of claim 11, wherein the one or more processors are configured to execute the computer-executable instructions and cause the processing system to provide the indication of differences to a user interface that is configured to display the indication of differences to a user.
